(19) United States
(12) Patent Application Publication
(10) Pub. No.: US 2006/0131543 A1
(43) Pub. Date: Jun. 22, 2006

(54) Polyaddition product and cationic electrodeposition coating comprising said polyaddition product

(76) Inventors: Hideki Iijima, Shiroyama-machi Tsukui-gun (JP); Koji Kamikado, Yokohama-shi (JP); Shigetaka Setodoi, Miyoshi-cho, Nishikamo-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/552,344

(22) PCT Filed: Mar. 30, 2004
(86) PCT No.: PCT/JP04/04500

§ 371 Date: Oct. 7, 2005

(30) Foreign Application Priority Data
Apr. 10, 2003 (JP) 2003-106047
Oct. 8, 2003 (JP) 2003-349810

(51) Int. Cl. C09K 11/06

(52) U.S. Cl. 252/301.16

(57) ABSTRACT

This invention provides a polyaddition product formed from amine compound having polyoxyalkylene chain(s) and monoepoxysilane, which has a weight-average molecular weight within a range of 250-10,000, as an additive of favorable paint stability. The polyaddition product gives, when used in cationic electropaints, coating film which is excellent in coating operability such as finished appearance, oil-cissing resistance, water mark insensibility; sealer adherability; and corrosion resistance.

### TECHNICAL FIELD

This invention relates to novel polyaddition products having a polyoxyalkylene chain, and to cationic electropaint containing the polyaddition product.

### BACKGROUND ART

Cationic electropaints are put to broad scope of uses typically for car bodies and car parts, and those having versatile characteristic properties have been developed.

Physical properties required for cationic electropaint include coating operability including good finished appearance, oil-cissing resistance, water mark insensibility and contamination resistance; and adherability to top coating film. These properties are of particular importance in such occasions as line-coating car bodies of complicated shapes.

With the view to improve these properties, methods of adding surface treating agents or the like to cationic electropaint have been proposed including, for example, the following methods (1) and (2).

Method (1): a method of kneading a surface treating agent into the paint to form an emulsion, e.g., a method comprising dispersing a surface treating agent in an aqueous medium concurrently with a main resin such as amine-added epoxy resin or the like, a hardening agent such as blocked polyisocyanate compound or the like and other additives, to form an emulsion; and forming a cationic electropaint using that emulsion and a pigment-dispersed paste.

Method (2): a method comprising first preparing a cationic electropaint bath using the emulsion and a pigment-dispersed paste, and adding to the bath a surface treating agent.

In the above method (1), dispersibility of the emulsion decreases to increase particle size of the emulsion because the surface treating agent is emulsified concurrently with a main resin or hardening agent, which is liable to impair stability of paint or to degrade finished appearance and corrosion resistance.

On the other hand, in the method (2) the surface treating agent may not be well compatible with the cationic electropaint bath or coating film formed of the paint, and is liable to cause equipment disorders such as occlusion of filter in filtering machine or UF filtering machine, coming off of sealer, peeling in intermediate or top coat, cissing and the like.

As a means for improving these drawbacks, for example, JP Hei 6 (1994)-76578B proposes to blend in a cationic electropaint cationic electro-depositable fine gel particles which are obtained by dispersing an epoxy resin-amine adduct containing hydrolyzable alkoxysilane groups in water, to impart to the formed coating film cissing-preventive effect derived from their surface treating effect. These cationic electro-depositable fine gel particles exhibit cissing preventive effect when they are added to a cationic electropaint after its formulation (i.e., applicable to the above method (2)), but when the cationic electropaint is given mechanical shear over a long period by circulating or stirring it with a pump, the fine particles give rise to such problems as degradation in finished appearance of surfaces coated therewith or reduction in paint stability.

JP2001-3005A discloses cationic electropaint whose finished appearance and anticorrosive effect do not deteriorate, which contains as surface treating agent polyether polyol such as alkylene polyether polyol, e.g., polymethylene glycol, polyethylene glycol, polypropylene glycol, polybutylene glycol and the like; bisphenol alone; or aromatic ring-containing polyether polyol such as a reaction product of bisphenol with glycol. However, those surface treating agents as described in JP2001-3005A lack water-dispersibility and hence cannot be added to advancedly formulated cationic electropaint bath. This makes it impossible to carry out fine adjustment for improving cissing resistance of the coated surfaces. Furthermore, when the treating agent is added in large quantities, reduction in adherability between the electrocoated film formed and sealer or intermediate or top coat may take place.

On the other hand, JP2001-288407A proposes to prevent oil cissing, dry marks and water marks on the coated surface, by addition to cationic electropaint, hydrophobic acrylic resin and ethylene oxide- and/or propylene oxide-adduct of higher alcohol having a specific molecular weight distribution and HLB. However, according to that method of JP2001-288407A, two substances, i.e., hydrophobic acrylic resin or ethylene oxide- and/or propylene oxide-adduct of higher alcohol having a specific molecular weight distribution and HLB, must be added as components of the emulsion and nevertheless the risk still remains that oil cissing or dry marks may occur depending on the blend ratio between the two substances, to impair coating operability.

JP2002-294165A proposes to add an amino ether-modified epoxy resin having a number-average molecular weight ranging 20,000-100,000 and polyether chain(s) which is obtained through reaction of diepoxy compound with amino polyether, to an electropaint as a surface treating agent. This surface treating agent can be added to electropaint as described in above method (2) post the latter's formulation. However, while it shows favorable stability under mild paint agitation (e.g., agitation in laboratory scale cans or small scale tanks), when it is subjected to shearing force over a prolonged period exerted by filtering machine with filter or UF filtering machine in coating lines, a part of the surface treating agent is liable to aggregate to cause such disorders as occlusion of said filtering machines or adhesion of nibs on the coated surface.

Therefore, development of a surface treating agent for cationic electropaint is in demand, which is applicable to both addition systems of above methods (1) and (2) and retains at good balance favorable finished appearance; high coating operability such as oil cissing resistance, water mark insensibility and contamination resistance; adherability to top coat; paint stability on coating lines; hardenability; and corrosion resistance.

### DISCLOSURE OF THE INVENTION

We engaged in concentrative studies aiming at meeting the demand, and now discovered that polyaddition products having weight-average molecular weight within a range of 250-10,000, which are obtained through reaction of polyether polyamine with monoepoxysilane are useful for both the method for kneading a surface treating agent into a paint in advance of emulsifying the same and the method of preparing a cationic electropaint bath and thereafter adding a surface treating agent and, furthermore, that cationic electropaint which contains the polyaddition product gives coating film excellent in coating operability such as finished appearance, oil cissing resistance, water mark insensibility, contamination resistance and the like, adherability to top coat paint, paint stability at coating lines, hardenability and corrosion resistance. Whereupon we have completed the present invention.

Accordingly, therefore, the invention provides a polyaddition product (A) of amine compound (a₁) having polyoxyalkylene chain(s) and monoepoxysilane (a₂), which has a weight-average molecular weight within a range of 250-10,000.

This invention also provides a cationic electropaint comprising, as the main resin, an amine-added epoxy resin which is obtained through an addition reaction between epoxy resin and amino-containing compound and, as the hardening agent, blocked polyisocyanate compound, into which the above polyaddition product (A) is blended or added within a range of 0.1-20 parts by weight per 100 parts by weight of combined solid components of the main resin and hardening agent.

Hereafter the polyaddition product and cationic electropaint according to the present invention are explained in further details.

Polyaddition Product (A):

The polyaddition product (A) of the present invention is obtained by reacting an amine compound (a₁) having polyoxyalkylene chain(s) with a monoepoxysilane (a₂), and it has a weight-average molecular weight within a range of 250-10,000.

Said amine compound (a₁) having a polyoxyalkylene chain(s) includes compounds having a polyoxyalkylene chain(s) (which may be composed of single kind of oxyalkylene units or two or more kinds of oxyalkylene units) and at least one, preferably 1-3, amino group(s), per molecule. More specifically, for example, compounds expressed by the following formulae (1), (2), (3) and (4) can be named. 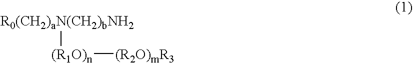
(in which R₀ stands for NH₂ or OH; R₁ and R₂ each stands for C₂H₄ or C₃H₆; R₃ stands for H, C₂H₅ or C₃H₇; a, b and n each is an integer of at least 1; and m is an integer not less than 0).

Specific examples of the compounds represented by above formula (1) include SANAMEEL TAP-10™ (weight-average molecular weight, about 600) and SANAMEEL TAP-40™ (weight-average molecular weight, about 2,300) (Sanyo Chemical Industries, Ltd.).
H₂N(CH₂)ₐO(R₁O)ₙ—(R₂O)ₘR₃ (2)
(in which R₁ and R₂ each stands for C₂H₄ or C₃H₆;

R₃ stands for H, C₂H₅ or C₃H₇,

a and n each is an integer of at least 1; and

m is an integer not less than 0).

Specific examples of the compounds represented by above formula (2) include SANAMEEL MAP-10™ (weight-average molecular weight, about 600) and SANAMEEL MAP-20™ (weight-average molecular weight, about 1,300) (Sanyo Chemical Industries, Itd.).

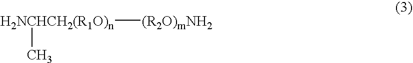

(in which R₁ and R₂ each stands for C₂H₄ or C₃H₆,

n is an integer of at least 1, and

m is an integer not less than 0).

Specific examples of the compounds represented by above formuma (3) include JEFFAMINE D400™ (weight-average molecular weight, about 400) and JEFFAMINE D2000™ (weight-average molecular weight, about 2,000) (Huntsman Chemical Corporation).

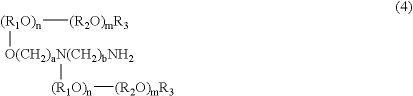

(in which R₁ and R₂ each stands for C₂H₄ or C₃H₆,

R₃ stands for H, C₂H₅ or C₃H₇,

a, b and n each is an integer of at least 1, and

m is an integer not less than 0).

Monoepoxysilane (a₂) includes those compounds having one epoxy group and one group represented by the following formula 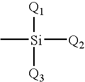
(wherein Q₁, Q₂, and Q₃ each stands for alkyl, alkoxy or alkylcarbonyloxy, with the proviso that at least one of Q₁, Q₂, and Q₃ is a group other than alkyl),
   per molecule, specific examples being those represented by the following formulae (5)-(11):

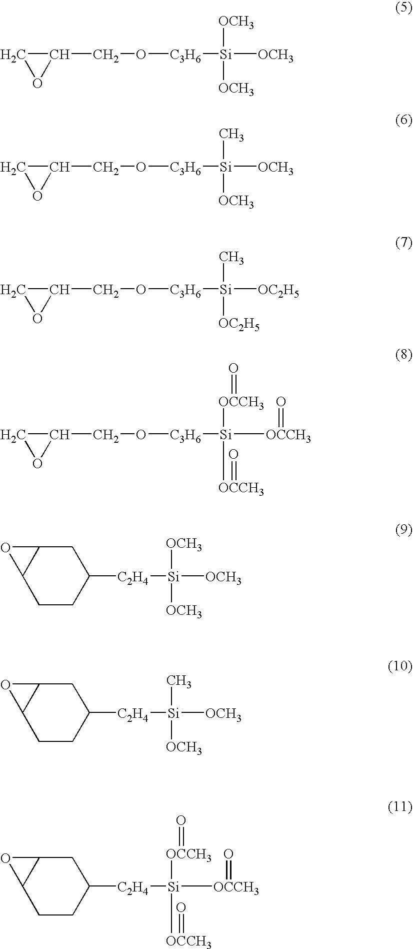

Polyaddition product (A) according to the present invention can be prepared by a ring-opening addition reaction of the amino group of amine compound (a₁) having a polyoxyalkylene chain with the epoxy group of monoepoxysilane (a₂) as described in the above. This ring-opening addition reaction can normally be conducted by stirring the reactants in an adequate inert solvent, at temperatures ranging about 50—about 130° C., preferably about 70—about 110° C., for around 30 minutes—6 hours, preferably around 1-3 hours. The use ratio of monoepoxysilane (a₂) to amine compound (a₁) is not critical, but it is generally preferred to use 0.5-2 moles, in particular, 0.5-1.5 moles, of monoepoxysilane (a₂) per mole of amino groups of amine compound (a₁). As useful solvent, for example, hydrocarbons such as toluene, xylene, cyclohexane, n-hexane and the like; esters such as methyl acetate, ethyl acetate, butyl acetate and the like; ketones such as acetone, methyl ethyl ketone, methyl isobutyl ketone, methyl amyl ketone and the like; amides such as dimethylformamide, dimethylacetamide and the like; alcohols such as methanol, ethanol, n-propanol, iso-propanol and the like; and mixtures of the foregoing can be named.

The reaction of an amine compound (a₁) with monoepoxysilane (a₂) is illustrated by the following reaction scheme, as to a case wherein the compound of above formula (1) and that of above formula (5) are used as the starting materials.

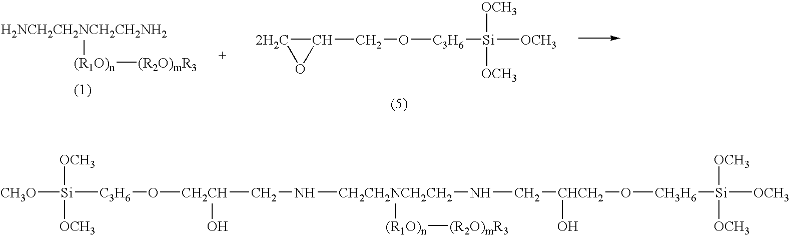

Thus a polyaddition product (A) having a weight-average molecular weight within a range of 250-10,000, preferably 500-6,000, inter alia, 1,000-3,000 can be obtained. Where weight-average molecular weight of the resulting polyaddition product (A) exceeds 10,000, stability of the polyaddition product decreases when shearing force is exerted thereto over a prolonged period at coating lines. Conversely, when the weight-average molecular weight is less than 250, its surface treating effect on coated surface becomes insufficient and the coated surface is apt to develop cissing. On the other hand, when weight-average molecular weight of the polyaddition product (A) falls within the above-specified range, the polyaddition product is stable even under prolonged shear exerted by filter machine or UF filter machine and does not cause such troubles as occlusion of filter or UF membrane or adhesion of nibs on coated surface.

Cationic Electropaint:

The polyaddition product (A) of the present invention can be dispersed together with main resin, hardening agent and other paint additives as described hereafter, to form an emulsion and thereafter used as cationic electropaint.

The polyaddition product (A) may also be neutralized with organic acid, e.g., acetic acid, formic acid or their mixtures, and then added with water and dispersed, to form an aqueous dispersion (A₁). This aqueous dispersion (A₁) can be post-added to an advancedly prepared cationic electropaint bath, e.g., during rest time of coating line or on holidays. The organic acid can be used within a range of 10-100, preferably 20-70, inter alia, 30-50, as converted to mgKOH per gram of solid resin component in the polyaddition product (A). When use rate of the organic acid is less than 10 mgKOH/g as converted to mgKOH per gram of the solid resin component, it becomes difficult to convert the polyaddition product (A) into an aqueous dispersion. Conversely, when it exceeds 100, acid concentration (MEQ) of the cationic electropaint to which the polyaddition product (A) is added rises and Coulomb efficiency decreases, which is liable to cause such a trouble that coating film fails to form when electricity is turned on or to give rise to a problem such that pinholes appear in coating of GA material (alloyed molten zinc-plated steel sheet).

Cationic electropaints with or to which the polyaddition product (A) can be blended or added according to the present invention are preferably those comprising as the essential components cationic resin which is used as the main resin and blocked polyisocyanate compound as the hardening agent.

Cationic resins useful as the main resin are the resins having cationizable groups in their molecules, such as amino, ammonium salt, sulfonium salt, phosphonium salt and the like groups. Any type of those resins which have been customarily used as main resin for electropaint, for example, epoxy-, acryl-, polybutadiene-, alkyd- or polyester-derived resins can be used. In particular, amine-added epoxy resin obtained by an addition reaction of amino-containing compound with polyepoxide compound is preferred.

As the amine-added epoxy resin, for example, (1) adducts of polyepoxide compound with primary mono- and poly-amines, secondary mono- and poly-amines or primary and secondary mixed polyamines (e.g., see U.S. Pat. No. 3,984,299); (2) adducts of polyepoxide compound with secondary mono- and poly-amines having ketiminated primary amino group(s) (e.g., see U.S. Pat. No. 4,017,438); and (3) reaction products obtained by etherification of polyepoxide compound and hydroxy compound having ketiminated primary amino group(s) (e.g., see JP Sho59 (1984)-43013A) can be named.

Polyepoxide compounds suitable for the preparation of amine-added epoxy resins have at least one, preferably at least two, epoxy groups per molecule and generally have a number-average molecular weight within a range of at least 200, preferably 400-4,000, inter alia, 800-2,500 and an epoxy equivalent of at least 160, preferably 180-2,500, inter alia, 400-1,500. In particular, those obtained through reaction of polyphenol compound with epichlorohydrin are convenient.

As the polyphenol compound useful for forming the polyepoxide compound, for example, bis(4-hydroxyphenyl)-2,2-propane, 4,4′-dihydroxybenzophenone, bis(4-hydroxyphenyl)-1,1-ethane, bis(4-hydroxyphenyl)-1,1-isobutane, bis(4-hydroxy-2- or 3-tert-butylphenyl)-2,2-propane, bis(2-hydroxynaphthyl)-methane, tetra(4-hydroxyphenyl)-1,1,2,2-ethane, 4,4′-dihydroxydiphenylsulfone, phenolnovolak, cresolnovolak and the like can be named.

The polyepoxide compounds may be those which are partially reacted with polyol, polyether polyol, polyester polyol, polyamidoamine, polycarboxylic acid, polyisocyanate compound or the like, or may further be graft-polymerized with caprolactone such as ε-caprolactone, acrylic monomer or the like.

As (1) the primary mono- and poly-amines, secondary mono- and poly-amines and primary and secondary mixed polyamines which are used for the preparation of amine-added epoxy resin, for example, mono- or di-alkylamines such as monomethylamine, dimethylamine, monoethylamine, diethylamine, monoisopropylamine, diisopropylamine, monobutylamine, dibutylamine and the like; alkanolamines such as monoethanolamine, diethanolamine, mono(2-hydroxypropyl)amine, monomethylaminoethanol and the like; and alkylene polyamines such as ethylenediamine, propylenediamine, butylenediamine, hexamethylenediamine, diethylenetriamine, triethylenetetramine and the like can be named.

As (2) secondary mono- and poly-amines having ketiminated primary amino group(s), which are used for the preparation of amine-added epoxy resin, for example, ketiminated products formed through reaction of those compounds having primary amino group(s) (e.g., monomethylamine, monoethanolamine, ethylenediamine, diethylenetriamine and the like), among the above primary mono- and poly-amines, secondary mono- and poly-amines and primary-secondary mixed polyamines useful for preparing the amine-added epoxy resin as in (1) above, with ketone compound can be named.

As (3) the hydroxy compounds having ketiminated primary amino groups, which are used for preparing the amine-added epoxy resin, for example, hydroxyl-containing ketiminated products formed through reaction of those compounds having primary amino group(s) and hydroxyl group(s) (e.g., monoethanolamine, mono(2-hydroxypropyl)amine and the like), among the above primary mono- and poly-amines, secondary mono- and poly-amines and primary-secondary mixed polyamines useful for preparing the amine-added epoxy resin as in (1) above, with ketone compound can be named.

The amine-added epoxy resin also includes polyol-modified, amine-added epoxy resin which is obtained by reacting above-described polyepoxide compound, polyol compound obtained by adding caprolactone to a compound having at least two active hydrogen-containing groups per molecule and amino-containing compound, and which can be conveniently used.

It is generally preferred for the compound having at least two active hydrogen-containing groups per molecule, to have a number-average molecular weight within a range of 62-5,000, in particular, 62-1,500, and have 2-30, in particular, 2-10 active hydrogen-containing groups per molecule. As examples of active hydrogen-containing group, hydroxyl, primary amino, secondary amino and the like can be named.

As specific examples of the compound having at least two active hydrogen-containing groups per molecule, low molecular weight polyols such as ethylene glycol, propylene glycol, 1,3-butylene glycol, 1,4-butanediol, 1,6-hexanediol, diethylene glycol, dipropylene glycol, neopentyl glycol, glycerine, trimethylolpropane, pentaerythritol and the like; linear or branched polyether polyols such as polyethylene glycol, polypropylene glycol, polytetramethylene glycol, bisphenol A polyethylene glycol ether and the like; polyester polyols obtained through polycondensation reaction of organic dicarboxylic acid such as succinic acid, adipic acid, azelaic acid, sebacic acid, maleic acid, cyclohexanedicarboxylic acid, phthalic acid, isophthalic acid, terephthalic acid and the like or anhydrides thereof with organic diols such as the above-named low molecular weight polyols, under a condition of organic diol excess; amine compounds such as butylenediamine, hexamethylenediamine, tetraethylenepentamine, pentaethylenehexamine, monoethanolamine, diethanolamine, triethanolamine, mono(2-hydroxypropyl)amine, di(2-hydroxypropyl)amine, 1,3-bisaminomethylcyclohexanone, isophoronediamine, xylylenediamine, methaxylylenediamine, diaminodiphenylmethane, phenylenediamine, ethylenediamine, propylenediamine, diethylenetriamine, triethylenetetramine and the like; polyamides, polyamidoamines, amine adducts with epoxy compound, ketimines, aldimines and the like which are derived from piperazine or these amine compounds.

As caprolactones to be subjected to an addition reaction with the compound having at least two active hydrogen-containing groups per molecule, γ-caprolactone, ε-caprolactone, δ-caprolactone and the like can be named. In particular, ε-caprolactone is preferred.

The addition reaction of the compound having at least two active hydrogen-containing groups per molecule with caprolactone can be conducted by per se known methods, and the polyol compound can be obtained by the addition reaction.

The amino-containing compound useful for preparing the polyol-modified, amine-added epoxy resin is a component for imparting cationic property, for cationizing the resin by introducing amino groups into the resin, which is a compound having at least one active hydrogen reactable with epoxy group. As specific examples of the compound, primary mono- and poly-amines, secondary mono- and poly-amines or mixtures of primary and secondary polyamines which are useful for the preparation of amine-added epoxy resin, as described in (1); secondary mono- and poly-amines having ketiminated primary amino groups which are useful for the preparation of amine-added epoxy resin as described in (2); and hydroxy compounds having ketiminated primary amino groups which are useful for the preparation of amine-added epoxy resin as described in (3) can be named.

The cationic resin generally has a number-average molecular weight within a range of 700-6,000, in particular, 850-5,000, inter alia, 1,000-4,000; and 0.5-3 equivalents, preferably 0.6-2.5 equivalents, inter alia, 0.7-2 equivalents, of cationic group per kilogram of the resin.

Where the cationic resin has amino as the cationizable group, the resin can be made water-soluble or water-dispersible by neutralizing it with an acid such as organic carboxylic acid, e.g., formic acid, acetic acid, propionic acid, lactic acid and the like, or inorganic acid such as hydrochloric acid, sulfuric acid and the like. Where the cationizable group is an onium salt group such as ammonium salt, sulfonium salt or phosphonium salt, the resin can be made water-soluble or water-dispersible as it is, without such neutralization.

The cationic resin can be used in the form of aqueous solution or aqueous dispersion, or of organic solvent solution. Cationic resins can be made suitable for cationic electrostatic coating, when neutralized with acid and dissolved or dispersed in an aqueous medium.

Xylene formaldehyde resin-modified, amino-containing epoxy resin can also be used as the main resin. Xylene formaldehyde resin-modified, amino-containing epoxy resin includes amino-containing epoxy resin which is obtained by reacting with an epoxy resin having an epoxy equivalent of 180-3,000, xylene formaldehyde resin and amino-containing compound.

As the epoxy resin useful as a starting material for the preparation of above amino-containing epoxy resin, those similar to the epoxy resins named for the above cationic resins are convenient.

Xylene formaldehyde resin assists internal plasticization (modification) of epoxy resin, which can be prepared, for example, through condensation reaction of xylene, formaldehyde and optionally phenols, in the presence of an acid catalyst.

As the formaldehyde, for example, industrially easily available compounds which generate formaldehyde, such as formalin, paraformaldehyde, trioxane and the like can be named.

Phenols encompass monovalent or divalent phenolic compounds having two or three reaction sites. More specifically, for example, phenol, cresol, para-octylphenol, nonylphenol, bisphenolpropane, bisphenolmethane, resorcin, pyrocatechol, hydroquinone, para-tert-butylphenol, bisphenolsulfone, bisphenol ether, para-phenylphenol and the like can be named, which may be used either singly or in combination of two or more. Of these, phenol and cresol are particularly convenient.

As the acid catalyst useful for the condensation reaction of xylene formaldehyde and optionally phenols, for example, sulfuric acid, hydrochloric acid, paratoluenesulfonic acid, oxalic acid and the like can be named. Generally, sulfuric acid is particularly preferred.

The condensation reaction can be conducted by, for example, heating the reaction system to a temperature at which xylene, phenols, water, formaline and the like which are present in the system reflux, normally about 80-about 100° C. The reaction can be completed normally in about 2-6 hours.

Through the heating reaction of xylene formaldehyde and optionally phenols in the presence of an acid catalyst under above-described conditions, xylene formaldehyde resin can be obtained.

Thus obtained xylene formaldehyde resin generally has a viscosity within a range of 20-50,000 centipoise (25° C.), preferably 25-35,000 centipoise, inter alia, 30-15,000 centipoise (25° C.). It is generally preferred for the resin to have a hydroxyl equivalent within a range of 100-50,000, in particular, 150-30,000, inter alia, 200-10,000.

Amino-containing compound is a cationic property-imparting component for cationizing the epoxy resin by introducing amino groups into the epoxy resin. Amino-containing compounds similar to those useful for preparing the cationic resin as described earlier can be used.

Above reactions with an epoxy resin of a xylene formaldehyde resin and amino-containing compound can be carried out in optional order. Whereas, it is generally convenient to simultaneously react the epoxy resin with a xylene formaldehyde resin and amino-containing compound.

The above addition reaction is normally conducted in an adequate solvent, at about 80-about 170° C., preferably about 90-about 150° C., for about 1-6 hours, preferably about 1-5 hours. As the useful solvent, for example, hydrocarbons such as toluene, xylene, cyclohexane, n-hexane and the like; esters such as methyl acetate, ethyl acetate, butyl acetate and the like; ketones such as acetone, methyl ethyl ketone, methyl isobutyl ketone, methyl amyl ketone and the like; amides such as dimethylformamide, dimethylacetamide and the like; alcohols such as methanol, ethanol, n-propanol, iso-propanol and the like; or mixtures of the foregoing can be named.

The use ratio of the reactants in the above addition reaction is not strictly limited but can be suitably varied. Suitable ranges are as follows, based on the combined solid weight of the three components, i.e., epoxy resin, xylene formaldehyde resin and amino-containing compound: epoxy resin, generally within a range of 50-90 wt %, preferably 50-85 wt %; xylene formaldehyde resin, generally within a range of 5-45 wt %, preferably 6-43 wt %; and amino-containing compound, generally within a range of 5-25 wt %, preferably 6-20 wt %.

As hardening agent which is used concurrently with above main resin, blocked polyisocyanate compound which is an approximately stoichiometric addition reaction product of a polyisocyanate compound with a blocking agent is preferred, from the viewpoint of hardenability and corrosion resistance.

As the polyisocyanate compounds used here, those conventionally known can be used, which include, for example, aromatic, aliphatic or alicyclic polyisocyanate compounds such as tolylene diisocyanate, xylylene diisocyanate, phenylene diisocyanate, diphenylmethane-2,4′-diisocyanate, diphenylmethane-4,4′-diisocyanate (MDI), crude MDI, bis(isocyanatomethyl)cyclohexane, tetramethylene diisocyanate, hexamethylene diisocyanate, methylene diisocyanate, isophorone diisocyanate and the like; cyclized polymers of these polyisocyanate compounds; isocyanate biurets; and terminal isocyanate group-containing compounds obtained by reacting excessive amounts of these polyisocyanate compounds with low molecular weight, active hydrogen-containing compounds such as ethylene glycol, propylene glycol, trimethylolpropane, hexanetriol, caster oil and the like. Those can be used each singly or in combination of two or more.

Whereas, blocking agent adds to isocyanate groups in the polyisocyanate compound to block them. It is desirable that the blocked polyisocyanate compound formed upon the addition is such that it is stable at ambient temperature but when heated to baking temperature of coating film (normally at about 100° C.-about 200° C.), can dissociate the blocking agent to regenerate free isocyanate groups.

As blocking agents which satisfy the above requirement, for example, lactam compounds such as ε-caprolactam, γ-butyrolactam and the like; oxime compounds such as methyl ethyl ketoxime, cyclohexanone-oxime and the like; phenolic compounds such as phenol, para-t-butylphenol, cresol and the like; aliphatic alcohols such as n-butanol, 2-ethylhexanol and the like; aromatic alkylalcohols such as phenylcarbinol, methylphenylcarbinol and the like; and ether alcohols such as ethylene glycol monobutyl ether, diethylene glycol monoethyl ether and the like can be named.

Besides these blocking agents, blocked polyisocyanate in which a diol of a molecular weight ranging 76-150 which has two hydroxyl groups differing in reactivity or a carboxyl-containing diol of a molecular weight ranging 106-500 is used as the blocking agent, can also be used as the hardening agent.

The diols can be those having two hydroxyl groups differing in reactivity, e.g., in such combination as primary hydroxyl group and secondary hydroxyl group, primary hydroxyl group and tertiary hydroxyl group, or secondary hydroxyl group and tertiary hydroxyl group, and also having a molecular weight ranging 76-150. As specific examples, diols having two hydroxyl groups differing in reactivity, such as propylene glycol, dipropylene glycol, 1,3-butanediol, 1,2-butanediol, 3-methyl-1,2-butanediol, 1,2-pentanediol, 1,4-pentanediol, 3-methyl-4,3-pentanediol, 3-methyl-4,5-pentanediol, 2,2,4-trimethyl-1,3-pentanediol, 1,5-hexanediol, 1,4-hexanediol and the like can be named.

Among these, propylene glycol is convenient from the viewpoints of reactivity of the blocked polyisocyanate, reduction in weight loss under heating and storage stability of the paint. Normally the hydroxyl group of the higher reactivity in these diols first reacts with isocyanate group, to block the latter.

The carboxyl-containing diols include those having a molecular weight ranging 106-500. Carboxyl groups in their molecules enable them to improve their low temperature dissociation and hence, low temperature hardenability. In particular, when organic tin compound is used as the hardening catalyst, the diols can markedly improve low temperature hardenability.

As examples of such carboxyl-containing diol, 2,2-dimethylolpropionic acid, 2,2-dimethylolbutanoic acid, dimethylolvaleric acid, glyceric acid and the like can be named.

The main resin and hardening agent as so far described can be generally used within such ranges as, based on the combined solid components of the two, 50-95 wt %, in particular, 60-90 wt %, inter alia, 65-85 wt % for the main resin; and 5-50 wt %, in particular, 10-40 wt %, inter alia, 15-35 wt % for the hardening agent.

Cationic electropaint according to the invention can contain such main resin and hardening agent, in terms of their combined solid components, at a concentration within a range of 10-40 wt %, in particular, 10-30 wt %, inter alia, 15-25 wt %.

The cationic electropaint can contain, in addition to the basic two components, i.e., main resin and hardening agent, other paint additives where necessary, for example, coloring pigment, extender pigment, antirusting pigment, organic solvent, pigment-dispersing agent, surface treating agent, surfactant, acid, catalyst and the like, each in conventionally used amount.

Polyaddition product (A) according to the present invention as so far described can be incorporated in cationic electropaint at any optional stage of the latter's preparation (hereafter referred to as “pre-addition method”) or added to advancedly formulated cationic electropaint (“post-addition method”).

In pre-addition method, for example, the polyaddition product (A) is dispersed in an aqueous medium, concurrently with main resin, hardening agent and optionally other paint additive(s) to form an emulsion, and a cationic electropaint can be formulated using the emulsion and pigment-dispersed paste.

In the occasion of preparing above emulsion, the polyaddition product (A), main resin, hardening agent and optionally other paint additive(s) are combined and thoroughly mixed to form a dissolved varnish, which then is dispersed in water by addition of a neutralizing agent selected from formic acid, acetic acid, lactic acid, propionic acid, citric acid, malic acid, sulfamic acid and mixtures of two or more of these acids, in an aqueous medium, to form an emulsion for cationic electropaint.

Suitable blend ratio of the polyaddition product (A) in respect of paint stability lies within a range of, as solid component, 0.1-20 wt parts, in particular, 0.5-15 wt parts, inter alia, 1-10 wt parts, per 100 parts by weight of combined solid components of the main resin and hardening agent.

In the post-addition method, first an organic acid such as acetic acid, formic acid, lactic acid or the like is added to the polyaddition product (A), in an amount in the range of, in terms of mgKOH per gram of solid component of the product, 10-100, preferably 20-70, inter alia, 30-50, to render the latter water-dispersible and form an aqueous dispersion of the polyaddition product (A).

Separately, those main resin, hardening agent and optionally other paint additives as described in the foregoing are made water-dispersible by addition of a neutralizing agent as conventionally practiced, to form an emulsion. By further adding a pigment-dispersed paste and, where necessary, further diluting it with an aqueous medium, a cationic electropaint is formulated.

By adding such an aqueous dispersion of the polyaddition product (A) to an advancedly prepared cationic electropaint, in an amount within a range of, as solid component, 0.1-20 wt parts, in particular, 0.5-15 wt parts, inter alia, 1-10 wt parts, per 100 wt parts of the combined solid weights of the main resin and hardening agent, cationic electropaint according to the invention can be obtained. Addition of the polyaddition product (A) can be conducted at the stage of the cationic electropaint application.

Thus formulated cationic electropaint of the present invention can be applied onto any desired substrate surface by cationic electrocoating.

The cationic electrocoating can be generally conducted using a cationic electropaint bath formed by diluting the paint formulation with deionized water or the like, to a solid component concentration in the bath of about 5-about 40 wt % and adjusting its pH to fall within a range of 5.5-9.0, normally under such conditions of bath temperature, 15-35° C., and load voltage, 100-400V.

The film thickness of cationic electropaint coat formed with use of a cationic electropaint of the present invention is subject to no special limitation, but generally preferred range is, in terms of hardened coating film, 10-40 μm, in particular, 10-25 μm. Suitable baking temperature lies within a range of, at the coated surface, from about 120—about 200° C., in particular, about 140-about 180° C.; and suitable baking time, 5-60 minutes, in particular, around 10-30 minutes.

Cationic electropaint containing the polyaddition product (A) according to the present invention exhibits excellent coating operability pertaining to finished appearance, oil cissing resistance, water mark insensibility, contamination resistance and the like properties of coated surface, and adherability to top coat paint. In particular, in occasions of line-coating car bodies of complicated shapes, polyaddition product (A) of the invention renders it very easy to improve or control coating operability, because it can be directly added to paint tanks in form of an aqueous dispersion, during the coating line is not operating (recess time, breaks between shifts, holidays, and the like).

Again, when pigment content in cationic electropaint is decreased to 5-18 wt %, generally the paint shows improved sedimentation property or re-dispersibility but its coating film surface tends to develop cissing. By contrast, the polyaddition product (A) does not reduce corrosion resistance of coated film, which allows its addition to cationic electropaint at a broad range of quantitative variation such as 0.1-20 wt parts. This remarkably improves coating operability.

### EXAMPLES

Hereinafter the present invention is explained more specifically, referring to working Examples, it being understood that the invention is not limited to these Examples only. In the following, parts and % are weight parts and weight %.

Preparation of Polyaddition Product (A):

### Production Example 1

A reaction vessel was charged with 1150 parts of SANAMEEL TAP-40 (tradename, Sanyo Chemical Corporation; polyetheramine, weight-average molecular weight, about 2300), 240 parts of KBM-403 (tradename, Shin-etsu Chemical Co.; γ-glycidoxypropyl trimethylsilane, molecular weight, about 240) and 345 parts of ethylene glycol monobutyl ether, and heated to 90° C. While maintaining this temperature, the reactants were stirred for 3 hours, to provide a polyaddition product No. 1 having a solid resin content of 80%, weight-average molecular weight of 2,800 and amine value of 40 mgKOH/g.

### Production Example 2

A reaction vessel was charged with 1000 parts of JEFFAMINE D-2000 (tradename, Huntsman Chemical Corporation; polyetheramine, weight-average molecular weight, about 2,000), 240 parts of KBM-403™ and 220 parts of ethylene glycol monobutyl ether and heated to 90° C. While maintaining this temperature, the reactants were stirred for 3 hours, to provide a polyaddition product No. 2 having a solid resin content of 80%, weight-average molecular weight of 2,500 and amine value of 45 mgKOH/g.

Preparation of Aqueous Dispersion:

### Production Example 3

To 1735 parts of the polyaddition product No. 1 as obtained in Production Example 1, 45 parts of acetic acid (which corresponds to 30 as converted to mgKOH per gram of the solid resin content) and 5170 parts of water were added to disperse the product in water. Thus an aqueous dispersion No. 1 having a solid content of 20% was obtained.

### Production Example 4

To 1550 parts of the polyaddition product No. 2 as obtained in Production Example 2, 40 parts of acetic acid (which corresponds to 30 as converted to mgKOH per gram of the solid resin content) and 4610 parts of water were added to disperse the product in water. Thus an aqueous dispersion No. 2 having a solid content of 20% was obtained.

### Production Example 5

A reaction vessel was charged with 320 parts of isopropyl alcohol and heated to reflux temperature (about 83° C.) under stirring, into which a mixture of the following monomers and polymerization initiator:

styrene 272 parts, n-butyl acrylate 224 parts; 2-hydroxyethyl acrylate, 80 parts; dimethylaminoethyl methacrylate 144 parts; KBM-503 (tradename, Shin-estu Chemical Industries; γ-methacryloxypropyl trimethoxysilane, molecular weight about 250) 80 parts; and azabisisobutyronitrile 24 parts was added dropwisely over about 2 hours, at reflux temperature (about 83-87° C.).

After further 30 minutes' stirring, a solution of 8 parts of azobisdimethylvaleronitrile in 120 parts of isopropyl alcohol was added to the system dropwisely over about an hour, followed by about an hour's stirring. Then 320 parts of isopropyl alcohol was thrown into the system and cooled, to provide an acrylic copolymer varnish having a solid content of 51%, amine value of 64, hydroxyl value of 48 and number-average molecular weight of approximately 20,000.

To 780 parts of this acrylic copolymer varnish, 6.4 parts of acetic acid was added and stirred for 5 minutes at about 30° C., followed by dropwise addition of 1156 parts of deionized water over about 30 minutes under violent stirring. Thus a milk-white aqueous dispersion No. 3 having a solid content of 20% was obtained.

### Production Example 6

(following Example 1 of JP2002-294165A)

A reaction vessel was charged with 129.7 parts of CHEMIOL EP-400P (tradename, Sanyo Chemical Industries; polypropylene glycol diglycidyl ether, epoxy equivalent 297), 99.6 parts of Versadyme 216 (tradename, Henckel-Hakusuisha; dimeric acid, acid value 192) and 0.6 part of benzyldimethylamine, which were allowed to react at 160° C. until the acid value dropped to no higher than 0.5, to provide a diepoxide having an epoxy equivalent of 2,300.

To this compound then 41.0 parts of aminopolyether having an amine value of 255 (tradename: AP-10, Sanyo Chemical Industries; diethylenetriamine-propylene oxide adduct, molecular weight 684) was added and the system was maintained at 80° C. for 4 hours to provide a compound having a number-average molecular weight of 27,000.

In a separate vessel 261.1 parts of this compound was added to a liquid mixture of 12.2 parts of 50% lactic acid and 379.1 parts of deionized water and stirred. Further adjusting with deionized water, an aqueous dispersion No. 4 having a solid content of 20% was obtained.

### Production Example 7

### Preparation of Main Resin No. 1

A 2-liter separable flask equipped with a thermometer, reflux condenser and stirrer was charged with 240 g of 50% formaline, 55 g of phenol, 101 g of 98% industrial sulfuric acid and 212 g of meta-xylene, which were reacted at 84-88° C. for 4 hours. After termination of the reaction, the flask was allowed to stand to separate the resin phase from aqueous sulfuric acid phase. The resin phase was washed three times with water, stripped off the unreacted meta-xylene for 20 minutes under the condition of 20-30 mmHg/120-130° C., to provide a xylene formaldehyde resin 1 having a viscosity of 1050 centipoise (25° C.).

Another flask was charged with 1000 g of EPICOAT 828EL (tradename, Japan Epoxy Resin Co.; an epoxy resin, epoxy equivalent 190, molecular weight 350), 400 g of bisphenol A and 0.2 g of dimethylbenzylamine, which were reacted at 130° C. until the epoxy equivalent rose to 750.

To the flask then 300 g of above xylene formaldehyde resin 1, 140 g of diethanolamine and 65 g of a ketiminated product of diethylenetriamine were added, allowed to react at 120° C. for 4 hours, followed by addition of 420 g of butylcellosolve, to provide main resin No. 1 which was a xylene formaldehyde-modified, amino-containing epoxy resin having an amine value of 52 and solid resin content of 80%.

### Production Example 8

### Preparation of Main Resin No. 2

To 400 g of PP-400 (tradename, Sanyo Chemical Industries, Ltd.; a polypropylene glycol, molecular weight 400), 300 g of ε-caprolactone was added and heated to 130° C. Then 0.01 g of tetrabutoxytitanium was added and the temperature was further raised to 170° C. While maintaining this temperature, the reaction system was sampled periodically to trace unreacted ε-caprolactone quantity by means of infrared absorption spectrum measurement. At the time point when the conversion reached not lower than 98%, the system was cooled to provide a modifier 1.

Separately, 400 g of bisphenol A and 0.2 g of dimethylbenzylamine were added to 1000 g of EPICOAT 828EL (tradename, Japan Epoxy Resin Co.; epoxy resin, epoxy equivalent 190 and molecular weight 350) and reacted at 130° C. until the epoxy equivalent rose to 750.

Then 120 g of nonylphenol was added to the reaction system and allowed to react at 130° C. until the epoxy equivalent rose to 1,000, followed by addition of 200 g of the modifier 1, 95 g of diethanolamine and 65 g of ketiminated diethylenetriamine, reaction at 120° C. for 4 hours, and addition of 414 g of butylcellosolve to provide main resin No. 2 which was a nonylphenol-added, polyol-modified amino-containing epoxy resin having an amine value of 40 and solid resin content of 80%.

### Production Example 9

### Preparation of Hardening Agent

To 270 g of COSMONATE M-200 (tradename, Mitsui Chemical Co.; crude MDI), 46 g of methyl isobutyl ketone was added, and heated to 70° C. Further 281 g of diethylene glycol monoethyl ether was added slowly, and the temperature was raised to 90° C.

While maintaining this temperature, the reaction system was sampled periorically until absence of absorption by unreacted isocyanate was confirmed by infrared absorption spectrum measurement, at which time point the reaction was suspended and the solvent quantity was adjusted to provide a blocked polyisocyanate hardening agent having a solid content of 90%.

### Production Example 10

### Preparation of Emulsion No. 1

A mixture was formed by blending and uniformly stirring 6.25 parts (solid content, 5 parts) of polyaddition product No. 1 as obtained in Production Example 1, 87.5 parts (solid content, 70 parts) of main resin No. 1 as obtained in Production Example 7, 33.3 parts (solid content, 30 parts) of the hardening agent as obtained in Production Example 9, 5 parts of SUNNIX PP-1000 ^{note 1)} and 8.2 parts of 10% formic acid. To the mixture 173.8 parts of deionized water was dropwisely added over about 15 minutes under vigorous stirring, to provide an emulsion No. 1 having a solid content of 34% for cationic electropaint.

### Production Examples 11-13

### Preparation of Emulsion Nos. 2-4

Using those blends as shown in Table 1, emulsion Nos. 2-4 for cationic electropaint were prepared in the manner similar to Production Example 10.

| | | Production | | Production | | Production | | Production | |
|---|---|---|---|---|---|---|---|---|---|
| | | Example 10 | | Example 11 | | Example 12 | | Example 13 | |
| Emulsion | | No. 1 | | No. 2 | | No. 3 | | No. 4 | |
| Polyaddition | 80% polyaddition | 6.25 | (5) | | | | | | |
| Product (A) | product No. 1 | | | | | | | | |
| | 80% polyaddition | | | 6.25 | (5) | | | | |
| | product No. 2 | | | | | | | | |
| Surface treating | SUNNIX PP-1000 | | | | | | | 5 | (5) |
| agent | (note 1) | | | | | | | | |
| Main resin | 80% main resin No. 1 | 87.5 | (70) | | | 87.5 | (70) | 87.5 | (70) |
| (B) | 80% main resin No. 2 | | | 87.5 | (70) | | | | |
| Hardening agent (C) | 90% hardening agent | 33.3 | (30) | 33.3 | (30) | 33.3 | (30) | 33.3 | (30) |

| | | | | | | | | |
|---|---|---|---|---|---|---|---|---|
| 10% Formic acid | 8.2 | | 8.2 | | 8.2 | | 8.2 | |
| Deionized water | 173.8 | | 173.8 | | 165 | | 175 | |
| 34% Emulsion | 309 | (105) | 309 | (105) | 294 | (100) | 309 | (105) |

(solid content)

(note 1)
SUNNIX PP-1000: tradename, Sanyo Chemical Industries, Ltd.; polypropylene glycol

### Production Example 14

### Preparation of Pigment-Dispersed Paste

Mixing 5.83 parts (solid content, 3.5 parts) of 60% quaternary ammonium salt-type epoxy resin, 14.5 parts of titanium white, 0.3 part of carbon black, 7.0 parts of extender, 1.0 part of bismuth hydroxide, 1 part of organic tin and 20 parts of deionized water, a pigment-dispersed paste having a solid content of 55.0 wt % was obtained.

### Examples and Comparative Examples

### Example 1

### Preparation of Cationic Electropaint No. 1

To 309 parts (solid content, 105 parts) of the emulsion No. 1 for cationic electropaint, 49.6 parts (solid content, 27.3 parts) of the pigment-dispersed paste as obtained in Production Example 14 and 173.8 parts of deionized water were added, to provide a cationic electropaint No. 1 having a solid content of 20%.

### Examples 2-4 and Comparative Examples 1-4

Cationic electropaint No. 2-No. 8 were prepared in the manner similar to Example 1, using the blends as shown in Table 2.

TABLE 2
Cationic Electropaint Composition

| | | Example | Example | Example | Example | Comparative | Comparative | Comparative | Comparative |
|---|---|---|---|---|---|---|---|---|---|
| | | 1 | 2 | 3 | 4 | Example 1 | Example 2 | Example 3 | Example 4 |
| | | cationic electropaint | | | | | | | |
| | | No. 1 | No. 2 | No. 3 | No. 4 | No. 5 | No. 6 | No. 7 | No. 8 |
| Paint | Emulsion No. 1 | 309 | | | | | | | |
| composition | (Polyaddition | | | | | | | | |
| | Product No. 1) | | | | | | | | |
| | Emulsion No. 2 | | 309 | | | | | | |
| | (Polyaddition | | | | | | | | |
| | Product No. 2) | | | | | | | | |
| | Emulsion No. 3 | | | 294 | 294 | 294 | | | |
| | Emulsion No. 4 | | | | | | 309 | | 309 |
| | Pigment-dispersed | 49.6 | 49.6 | 49.6 | 49.6 | 49.6 | 49.6 | 49.6 | |
| | paste | | | | | | | | |
| | deionized water | 302 | 302 | 293 | 293 | 293 | 302 | 302 | 276 |
| | 20% bath | 661 | 661 | 637 | 637 | 637 | 661 | 661 | 619 |
| Aqueous | Aqueous | | | 25 (5) | | | | | |
| dispersion | dispersion No. 1 | | | | | | | | |
| | Aqueous | | | | 25 (5) | | | | |
| | dispersion No. 2 | | | | | | | | |
| | Aqueous | | | | | | | 25 (5) | |
| | dispersion No. 3 | | | | | | | | |
| | Aqueous | | | | | | | | 25 (5) |
| | dispersion No. 4 | | | | | | | | |

Preparation of Test Panels

Using each of those cationic electropaints obtained in above Examples and Comparative Examples, 150 mm×70 mm×0.8 mm cold-rolled dull steel sheet and zinc-plated steel sheet which had been chemically treated with PALBOND#3020 (tradename, Japan Parkerizing Co.; zinc phosphate treating agent) were electrocoated. The coated film was baked in an electric hot air dryer at 170° C. for 20 minutes, to provide test panels.

Thus obtained test panels were given the tests under the following test conditions. The results were as shown in Table 3.

TABLE 3
Test Result

| | | Example | Example | Example | Example | Comparative | Comparative | Comparative | Comparative |
|---|---|---|---|---|---|---|---|---|---|
| | | 1 | 2 | 3 | 4 | Example 1 | Example 2 | Example 3 | Example 4 |
| | | cationic electropaint | | | | | | | |
| | | No. 1 | No. 2 | No. 3 | No. 4 | No. 5 | No. 6 | No. 7 | No. 8 |
| Test | finished appearance (note 6) | ∘ | ∘ | ∘ | ∘ | ∘ | ∘ | Δ | ∘ |
| result | oil cissing resistance (note 7) | ∘ | ∘ | ∘ | ∘ | Δ | ∘ | ∘ | ∘ |
| | water mark insensibility (note 8) | ∘ | ∘ | ∘ | ∘ | Δ | Δ | ∘ | Δ |
| | sealer adherability (note 9) | ∘ | ∘ | ∘ | ∘ | ∘ | x | ∘ | ∘ |
| | corrosion resistance (note 10) | ∘ | ∘ | ∘ | ∘ | ∘ | Δ | Δ | Δ |
| | paint stability (note 11) | ∘ | ∘ | ∘ | ∘ | ∘ | Δ | x | Δ |

(note 6) Finished Appearance

Surface roughness at the outermost surface of electrocoated film was evaluated by measuring Ra value with SURFTEST301 (tradename, MITSUTOYO Co.; surface roughness meter):

◯: Ra value less than 0.25 μm

Δ: Ra value 0.25-0.35 μm

×: Ra value exceeding 0.35 μm.

(note 7) Oil Cissing Resistance

On each of the still wet sheet after the electrocoating, a crown filled with 1 ml of machine oil was placed. Thereafter the condition of 170° C.-20 minutes' baked coated surface was observed:

◯: no cratering or cissing, good

Δ: crating found here and there at a part of the coated surface

×: cissing reaching to the substrate observed all over the coated surface.

(note 8) Water Mark Insensibility

On each of the still wet sheet after the electrocoating, 1 ml of deionized water was dropped, followed by the baking:

◯: water mark almost invisible, no problem with finished appearance

Δ: water mark confirmable, finished appearance degraded

×: water mark distinctly confirmable, heavy degradation in finished appearance.

(note 9) Sealer Adherability

Each test panel was coated with SUNSTAR1065T (tradename, Sunstar Inc.; a sealer) over a size 10 mm×6 mm×6 mm (longitudinal length×horizontal length×thickness). Thus coated panel was perpendicularly hanged and slippage of the sealer 12 hours after was measured:

◯: no slippage, no problem

Δ: sealer slippage by not more than 5 mm

×: sealer slipped off the coated sheet and fell.

(note 10): Corrosion Resistance

In the coated film on each of the electrocoated panel (the chemically treated zinc-plated steel sheet) after the baking at 170° C. for 20 minutes, cross-cuts were given with a knife to the depth reaching the substrate. The test panel was then subjected to a salt water spray resistance test for 840 hours according to JIS Z-2371, and rust and blistering width (single side) from the knifed scar was evaluated:

◯: rust and blistering width less than 3 mm (single side)

Δ: rust and blistering width 3 mm-less than 4 mm (single side)

×: rust and blistering width exceeding 4 mm (single side).

(note 11) Paint Stability

Each paint was circulated for 12 hours at 30° C. using a laboratory pump, and thereafter passed through 400 mesh filter net. The resulting filtering residue was measured:

◯: not more than 10 mg/L

Δ: 11-20 mg/L

×: exceeding 20 mg/L.

1. A polyaddition product of amine compound (a₁) having a polyoxyalkylene chain or chains and monoepoxysilane (a₂), which has a weight-average molecular weight within a range of 250-10,000.

2. A polyaddition product as set forth in claim 1, in which the amine compound (a₁) having a polyoxyalkylene chain or chains is selected from the group consisting of the compounds represented by the following formulae (1), (2), (3) and (4); 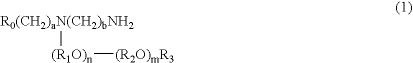
(in which R₀ stands for NH₂ or OH; R₁ and R₂ each stands for C₂H₄ or C₃H₆; R₃ stands for H, C₂H₅ or C₃H₇; a, b and n each is an integer of at least 1; and m is an integer not less than 0);
H₂N(CH₂)ₐO(R₁O)ₙ—(R₂O)ₘR₃ (2)
(in which R₁ and R₂ each stands for C₂H₄ or C₃H₆;
R₃ stands for H, C₂H₅ or C₃H₇,
a and n each is an integer of at least 1; and
m is an integer not less than 0); and 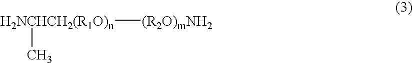
(in which R₁ and R₂ each stands for C₂H₄ or C₃H₆,
n is an integer of at least 1, and
m is an integer not less than 0); 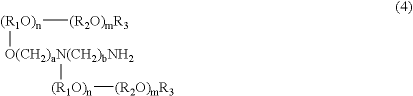
(in which R₁ and R₂ each stands for C₂H₄ or C₃H₆,
R₃ stands for H, C₂H₅ or C₃H₇,
a, b and n each is an integer of at least 1, and
m is an integer not less than 0).

3. A polyaddition product as set forth in claim 1, in which the monoepoxysilane (a₂) is selected from the group consisting of the compounds represented by the following formulae (5)-(11):

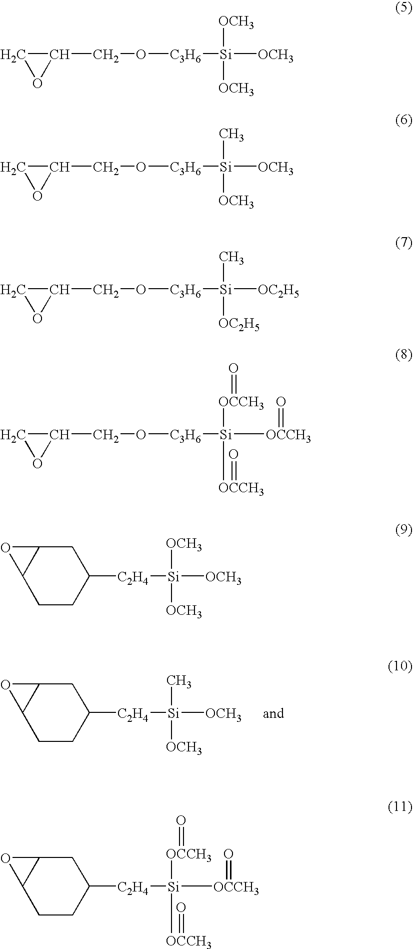

4. A polyaddition product as set forth in claim 1, which is obtained by subjecting the amine compound (a₁) having a polyoxyalkylene chain or chains and the monoepoxysilane (a₂) to a ring-opening addition reaction, at a ratio of 0.5-2 moles of the monoepoxysilane per mole of amino groups of the amine compound.

5. A polyaddition product as set forth in claim 1, which has a weight-average molecular weight within a range of 1,000-3,000.

6. A cationic electropaint which comprises an amine-added epoxy resin obtained by addition reaction of amino-containing compound with epoxy resin or a xylene formaldehyde resin-modified, amino-containing epoxy resin as the main resin; and blocked polyisocyanate compound as the hardening agent, to which paint a polyaddition product as set forth in any one of claims 1-5 is added at an optional stage of the paint formulation, at a ratio of 0.1-20 parts by weight per 100 parts by weight of combined solid compounds of the main resin and the hardening agent.

7. A cationic electropaint comprising an advancedly formulated cationic electropaint to which 0.1-20 parts by weight of an aqueous dispersion of a polyaddition product as set forth in any one of claims 1-5 is added per 100 parts by weight of combined solid components of the main resin and the hardening agent, said aqueous dispersion being prepared by adding an organic acid to the polyaddition product at a ratio within a range of 10-100 as converted to mgKOH per gram of solid component and dispersing it in water.

8. Coated articles which are electrocoated with a cationic electropaint as set forth in claim 6 or 7.
